(19) United States
(12) Patent Application Publication
(10) Pub. No.: US 2025/0132569 A1
(43) Pub. Date: Apr. 24, 2025

(54) DISTRIBUTED CONTROL METHOD BASED UPON THE COLLECTIVE BEHAVIOUR OF A NEW GENERATION PHOTOVOLTAIC FIELD

(71) Applicant: ENEL GREEN POWER S.P.A., Rome (RM) (IT)

(72) Inventors: Patrick MERHEJ, Rome (RM) (IT); Fabrizio BIZZARRI, Rome (RM) (IT); Daniele PROIETTI, Rome (RM) (IT)

(73) Assignee: ENEL GREEN POWER S.P.A., Rome (RM) (IT)

(21) Appl. No.: 18/574,385

(22) PCT Filed: Jul. 5, 2022
(86) PCT No.: PCT/IB2022/056195

§ 371 Date: Dec. 27, 2023

(30) Foreign Application Priority Data
Jul. 12, 2021 (IT) 102021000018236

(51) Int. Cl. H02J 3/38

(52) U.S. Cl. CPC H02J 3/38; H02J 2300/26

(57) ABSTRACT

The present invention relates to a distributed, self-stable control method, without direct exchange of information for a network of several power sources, in particular for applications related to an active converter for a photovoltaic module.

The present invention relates to a distributed, self-stable control method, without direct exchange of information for a network of several power sources, in particular for applications related to an active converter for a photovoltaic module.

### BACKGROUND

As it is known, a photovoltaic module (solar cell arrays) is formed by a predetermined number of solar cells connected to each other in series and/or in parallel, a string consists of a predetermined number of photovoltaic modules connected to each other in series and a photovoltaic array consists of a predetermined number of strings connected to each other in parallel.

The length of a string (in terms of modules connected in series) is function of a voltage threshold V_{dc-th}, and of the maximum voltage reached by a module, V_{oc-max}.

The voltage threshold value V_{dc-th} depends upon the local regulation of the low voltage directive, for example for the EU countries the real value nowadays corresponds to 1500V.

The maximum voltage reached by a module conventionally corresponds under the open circuit voltage condition to a high radiation value and to a low temperature value.

Consequently, the string length is obtained by using the equation (1):

$$n = string length ∝ \frac{{V}_{d c - th}}{{V}_{oc - max}} \qquad ( 1 )$$

For example, upon considering a PV module with V_{oc-max}=50V, the string may consist at maximum of 30 PV modules connected in series, independently from any other consideration.

The maximum power provided by a photovoltaic array, P_{max-array}, is a function of the peak power of the PV module Pₘₐₓ, of the string length n, and of the number N of strings connected in parallel.

Consequently, the maximum power provided by a photovoltaic array is shown in the equation (2).

$${P}_{max - array} = {P}_{max} * n * N \qquad ( 2 )$$

By way of example, if one considers two different photovoltaic arrays, FV1 and FV2, consisting of identical PV modules and which provide the same amount of maximum power, it will be possible to obtain the equation (3).

$${n}_{1} \cdot {N}_{1} = {n}_{2} \cdot {N}_{2} \qquad ( 3 )$$

Assuming that it is possible to equip the array FV2 with a longer string than that composing the array FV1 with an amount equal to L, it will be possible to calculate n₂ by using the equation (4).

$${n}_{2} = L {n}_{1} ; wherein L >= 1 \qquad ( 4 )$$

By using the equation (3) and the equation (4), it will be possible to deduce the equation:

$${N}_{2} = \frac{{N}_{1}}{L} \qquad ( 5 )$$

From the equation (5) it is possible to understand that the FV2 array could consist of a lower number of strings, with respect to the array FV1, of a factor equal to 1/L.

Then, by referring in particular to photovoltaic systems on industrial scale, it is particularly important, under various profiles, to be able to size suitably the length of a string.

As seen above, the length of a string is determined by the ratio between the voltage value admitted by the low voltage directive and the maximum voltage value which could be reached by a photovoltaic module.

Moreover, the length of a string could be expressed as economic function of parameters related to a photovoltaic system such as the system balancing cost, the time for installing a photovoltaic array which connects in parallel several strings and the architecture electric simplicity.

Then, it is evident that it would result to be advantageous, under different profiles, to have available strings formed by a high number of modules in series, preferably at least until the mechanical saturation of a tracker which nowadays can manage up to 90 modules which form 3 or 4 electrically separated strings.

However, nowadays, no solution among the proposed ones allows to configure strings without length limitation and at the same time guarantee the correct operation of the system and the compliance—in each possible situation—with the low voltage directives imposing a maximum voltage value.

In EP 3 907 875 A1 a method is illustrated wherein the circuit controlling the electronics implemented at the photovoltaic module level modifies the output impedance of the converter to highlight an operation status of the module itself. However, this does not allow to verify its connection state with the remaining system: either the photovoltaic module with integrated DC-DC alone or the photovoltaic module with integrated DC-DC connected to form a string or the photovoltaic module with integrated DC-DC connected to form a string and connected to the inverter or the photovoltaic module with integrated DC-DC connected to form a string and connected to the inverter and to the network or to the load.

### Technical Problem Solved by the Invention

The object of the present invention then is to solve the problems left unsolved by the know art, by providing an active electronic converter as defined in claim 1 or in claim 8.

Additionally, the present invention relates to a photovoltaic module as defined in the independent claim 10.

Still additionally, the present invention relates to a string of photovoltaic modules as defined in claim 11.

Still additionally, the present invention relates to a method for controlling a converter for photovoltaic modules as defined in claim 12 or in claim 18.

Additional features of the present invention are defined in the corresponding depending claims.

With respect to the state of art, the proposed solution is preferably applied at the module level by modifying actively the output electric feature thereof by allowing to prepare strings consisting of a very high number of photovoltaic modules in case by filling-in a tracker with one single string of modules connected in series, this resulting advantageous in terms of economic parameters such as the system balancing cost, the installation time, the simplicity of electric architecture, etc.

According to the present invention, since in the above-illustrated equation (1) it is not possible to modify the numerator as a matter of regulation, one chose to control the denominator related to the terminal output of the photovoltaic module.

This was obtained by integrating—in the photovoltaic module—an electronic device configured to control and limit the output voltage of the module and/or to modify the electric behaviour thereof.

The control is independent for each photovoltaic module, it does not require information exchange nor between the photovoltaic modules nor between the photovoltaic module and the inverter. Moreover, the control keeps low the output voltage of the photovoltaic module under open circuit conditions and recognizes the active connection towards the inverter and towards the load.

Thanks to such invention, the string can be connected in a simple way directly to a DC link element without the need for additional conditioning devices.

Still, the Applicant noted that through the present invention it is possible to work at an operating voltage of a DC link so as to be advantageously very near to the maximum voltage referred to the standards and there is not the need for managing the string voltage under open circuit conditions since it is regulated in a different level of the total system.

Other advantages, together with the features and the use modes of the present invention, will result evident from the following detailed description thereof, shown by way of example and not for limitative purposes.

### BRIEF DESCRIPTION OF FIGURES

Hereinafter in this description the drawings shown in the enclosed figures will be referred to, wherein:

FIGS. 1a, 1b and 1c show respectively a schematic block representing a photovoltaic module, a photovoltaic module connected to an impedance load and an example of an electric output feature (v, i)* in direct polarization area obtained by varying the impedance value z at a given temperature of module T*, and at a given radiation value G* received by the module;

FIG. 2 shows a block diagram exemplifying a module according to the invention, equipped with a converter circuit;

FIGS. 3a, 3b and 3c show examples of electric characterization respectively of a standard photovoltaic module by varying the impedance value, a standard photovoltaic module with MPPT function and a module using the present invention when it is connected to the network through the inverter, for three different environmental cases;

FIG. 4 exemplifies a possible electric model of module according to the present invention;

FIG. 5 extends the model of FIG. 4 to a string of modules;

FIG. 6 relates to a case wherein, in the string of FIG. 5, a defined number ‘a’ of modules according to the invention are active;

FIG. 7 is an example of module according to the present invention; and

FIG. 8 is a possible flow chart describing the control logic according to the present invention.

### DETAILED DESCRIPTION OF PREFERRED EMBODIMENTS

The present invention will be described hereinafter by making reference to the above-mentioned figures.

### Typical Behaviour of a Photovoltaic Module

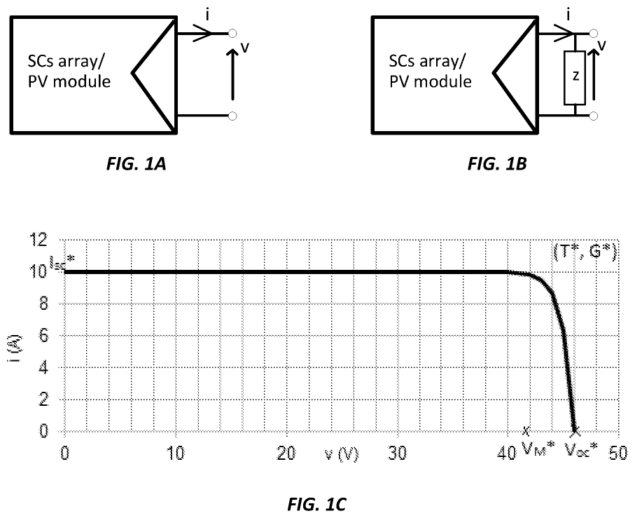

FIGS. 1a, 1b and 1c show respectively a schematic block representing a standard photovoltaic module, a standard photovoltaic module connected to an impedance load z and an example of typical electric output (v, i)* in direct polarization area obtained by varying the value of z at a given T* and a given G*.

The characteristic curve of electric output (v, i) of a standard photovoltaic module is an implicit function wherein the output current i depends exponentially upon the output current and upon the output voltage v.

Given a predetermined radiation value G*, received by the considered module and a given temperature value T*, reached by the module, there is one single corresponding curve (v, i)*.

In the direct polarization area wherein the output voltage of the module varies between 0V and the open circuit voltage V_{oc}, it is possible to detect the following three characteristic points for a given (T*, G*):
short circuit conditions (0, I_{sc}*), wherein v is equal to 0 and i corresponds to the short circuit current I_{sc}.
maximum power point (V_{M}*, I_{M}*), wherein v is equal to V_{M}* and i corresponds to I_{M}* (condition of maximum power P_{M}* extractable from the photovoltaic module)
open circuit conditions (V_{oc*}, 0), wherein v is equal to V_{oc}*and i is equal to 0.

The main limit due to the use of a fixed load is given by the fact that it is not possible to keep trace of changes in environmental conditions (T, G) since the maximum power point changes consequently.

It is possible to overcome this limit by introducing the use of an active electronic converter which, depending upon the needs, could implement a function of Maximum Power Point Tracker (MPPT).

The active electronic converters generally are switching circuits, such as buck, boost, buck-boost, bridge capacitors, bridge inductors or any circuit organized by a combination between inductors, capacitors and transistors since they offer a high efficiency (typically>98%).

To the purposes of the present description one will refer, by way of example, to a circuit of buck type. However, it is to be meant that the present invention could be implemented in presence of any one of the circuits usually provided for the implementation of MPPT function, or even when such function is not implemented.

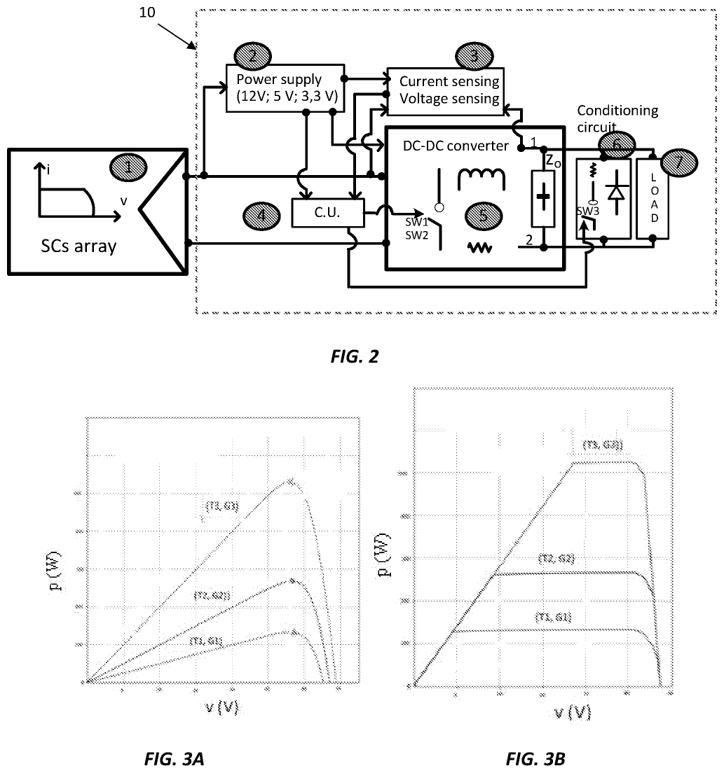

FIG. 2 shows a scheme exemplifying a module according to the invention, equipped with a converter circuit 10 with conditioning circuit.

In FIG. 2 the blocks 1 to 7 represent, respectively, one or more photovoltaic modules 1 (each module comprising an array of solar cells), power supply 2, electric sensors 3, a controller 4, electric components forming a converter DC-DC together with a first switching device SW1, SW2, the conditioning circuit 6 comprising a second switching device SW3, and the load 7.

As it is known, an MPPT algorithm has the function of tracing the value of the optimum operating voltage and/or of the optimum operating current; the first switching device of the active electronic converter will be suitably controlled to pursue the optimum operating point. The MPPT algorithm generally is performed by using a microcontroller or the like. Depending upon the type of MPPT algorithm, the mathematical operation could be based upon the detection of one or a combination of the following parameters: current, voltage, temperature and photovoltaic radiation.

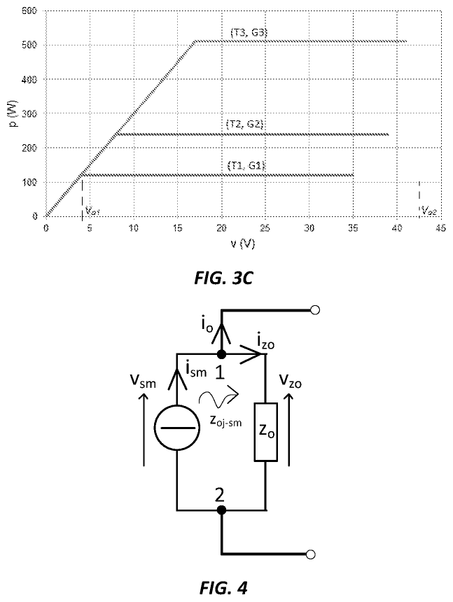

FIGS. 3a, 3b and 3c show examples of electric characterization respectively of a standard panel upon varying the impedance, a standard panel with MPPT function and a panel using the present invention by using—for example—a converter of buck type connected to the network through an inverter, for three different environmental cases.

In FIG. 3b it is possible to distinguish three different working areas:
Area 1, up to Vₒ₁: the output power depends linearly upon v since it is a feature of the hardware project.
Area 2, belonging to [Vₒ₁, Vₒ₂]: extension of the operation range to V_{M}. The value of Vₒ₂ is dynamic and depends both upon the number of modules connected in series according to the present invention and upon the power mismatch between the modules belonging to the same string.
Area 3: the output power strongly depends upon the behaviour of the open circuit voltage and it is function of a voltage lower than V_{ref1} (defined in details later).

According to the present invention, one provides to apply an active electronic converter to a standard photovoltaic module, that is to a set of solar cells connected to each other to form an array, then to give shape to an improved, or ‘smart’ module.

An electric model of smart module could be represented by a current generator, iₛₘ, and by an impedance, zₒ. Wherein iₛₘ is the current generated by the photovoltaic module, integrated or derived from the active electronic circuit and measured before the node 1, as shown in FIG. 4, before being divided into two portions, as shown in the following equation (6): current circulating in the output impedance of the electronic circuit “i_{zo}” and in the output “iₒ”.

The output impedance of the active electronic circuit, zₒ, consists of the equivalent impedance, calculated or measured (directly or indirectly) between the node 1 and the node 2. Typically, zₒ is characterized by a capacitive effect representing the electric output of the converter.

A conditioning circuit implemented in parallel to the output impedance zo, comprises, preferably, between the node 1 and the node 2:
an active switching element, adapted to form a local shunt circuit: for example, a transistor connected in series to a resistance.
a passive element, apt to limit the negative voltage at the output of the converter: for example, a diode.

The conditioning circuit has the purpose of forming a stable system. More in details, said shunt circuit allows to adjust the output voltage with lower periods of time than those which can be obtained thanks to the single dynamics of the converter DC-DC and in particular to reduce the output voltage quickly by closing the switch SW3, and said passive element is advantageously useful to act, for example, as bypass in case a dc/dc system is not operating and even in a phase of initial start of the system so as to succeed in avoiding that the voltage of capacitor reaches negative values.

The voltage, vₛₘ o v_{zo}, is the voltage measured or calculated between the node 1 and 2 which represents the voltage at level zₒ, as shown in the equation (7).

At last, the impedance measured (directly or indirectly) or calculated between the node 1 and the node 2 is defined by zₒ₋ₛₘ and calculated by the fraction of vₛₘ and of iₛₘ as shown in the equation (8).

$${i}_{s m} = {i}_{z o} + {i}_{o} \qquad ( 6 )$$

$${v}_{s m} = {z}_{o} \cdot {i}_{z o} \qquad ( 7 )$$

$${z}_{o - sm} = \frac{{v}_{s m}}{{i}_{s m}} = \frac{{z}_{o} \cdot {i}_{z o}}{{i}_{z o} + {i}_{o}} = {z}_{o} ; quando {i}_{o} = 0 \qquad ( 8 )$$

When the module output terminals, node 1 and node 2, are not connected, iₒ will be equal to zero; consequently zₒ₋ₛₘ will coincide with zₒ (the conditioning circuit represented with its equivalent impedance z_{co} results to be open)

For example, in case the output of the smart module is represented by a capacity C, the module of the apparent capacity calculated between the node 1 and the node 2 is coincident with the physical capacity C.

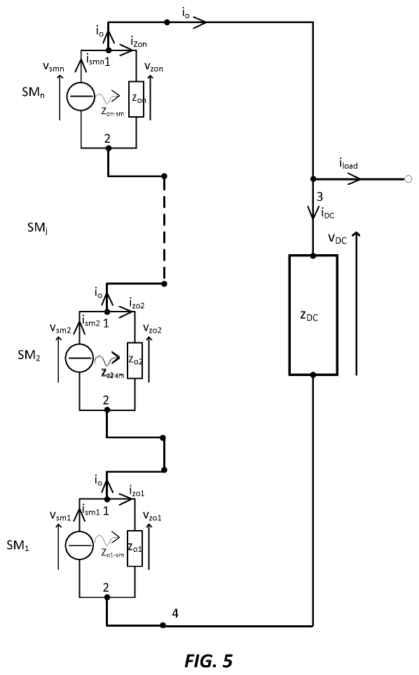

Considering a string of smart modules consisting of n modules connected in series to an intermediate circuit represented by an impedance z_{DC} (for example the input of a dedicated inverter with DC link), it will be possible to obtain the equivalent electric circuit shown in FIG. 5.

The previously described electric parameters will be designated by the index j wherein j represents the consecutive index of the general module of the string.

The output current, iₒ of the string consisting of n modules will be divided into load current, designated by i_{load}, and DC link current, designated by i_{DC} as shown in the equation (9).

The voltage V_{DC}, measured between the node 3 and the node 4 (as shown in FIG. 5 or 6), represents the DC link voltage and is calculated as shown in the equation (10)

$${i}_{o} = {i}_{load} + {i}_{D C} \qquad ( 9 )$$

$${v}_{D C} = {z}_{D C} . {i}_{D C} \qquad ( 10 )$$

Considering the j-th module in a string consisting of n modules and connected to an intermediate circuit, it is interesting to calculate the parameter zₒⱼ₋ₛₘ which represents the impedance observed by the module j-th at its output terminals 1 and 2.

Under normal conditions, it is possible to consider that the voltage, vₛₘ₋ⱼ, is a fraction of V_{DC} as shown in the equation (11)

$${v}_{s m j} = \frac{{v}_{D C}}{n} \qquad ( 11 )$$

Considering the case wherein i_{load} is equal to zero, by using the equations (9), (10) and (11) vₛₘⱼ will be as shown in the equation (12)

$${v}_{s m j} = \frac{{z}_{D C} . {i}_{o}}{n} \qquad ( 12 )$$

At the same time, considering the equations at level of module j-th shown in the equations (6) and (7), it is possible to write vₛₘⱼ as in the following equation (13):

$${v}_{s m j} = {z}_{o j} ( {i}_{s m j} - {i}_{o} ) \qquad ( 13 )$$

By replacing the value of iₒ obtained by the equation (12) in the equation (13), it is possible to obtain the division between vₛₘⱼ and iₛₘⱼ; consequently zₒⱼ₋ₛₘ of the module j-th is shown in the equation (14):

$${z}_{o j - s m} = \frac{{z}_{o j} . {z}_{D C}}{{z}_{D C} + n . {z}_{o j}} \qquad ( 14 )$$

In the practical use, it is possible to write the value of z_{DC} as a times lower than zₒⱼ, (z_{DC}=zₒⱼ/α). Consequently, Zₒⱼ₋ₛₘ will be a function of n, α and zₒⱼ, as shown in the equation (15):

$${z}_{o j - s m} = {z}_{o j} \frac{1}{1 + n α} \qquad ( 15 )$$

For example, in case the DC link is represented by a capacity C_{dc} and the output impedance observed by each module is represented by a capacitor ‘C’ where C_{dc}=αC, the value of zₒⱼ will be equal by definition to 1/SC wherein S is the Laplace operator and zₒⱼ₋ₛₘ will be equal to 1/(SC (1+nα)); it means that the module of apparent capacity measured between the node 1 and the node 2 is higher than the physical capacity by a factor equal to (1+nα).

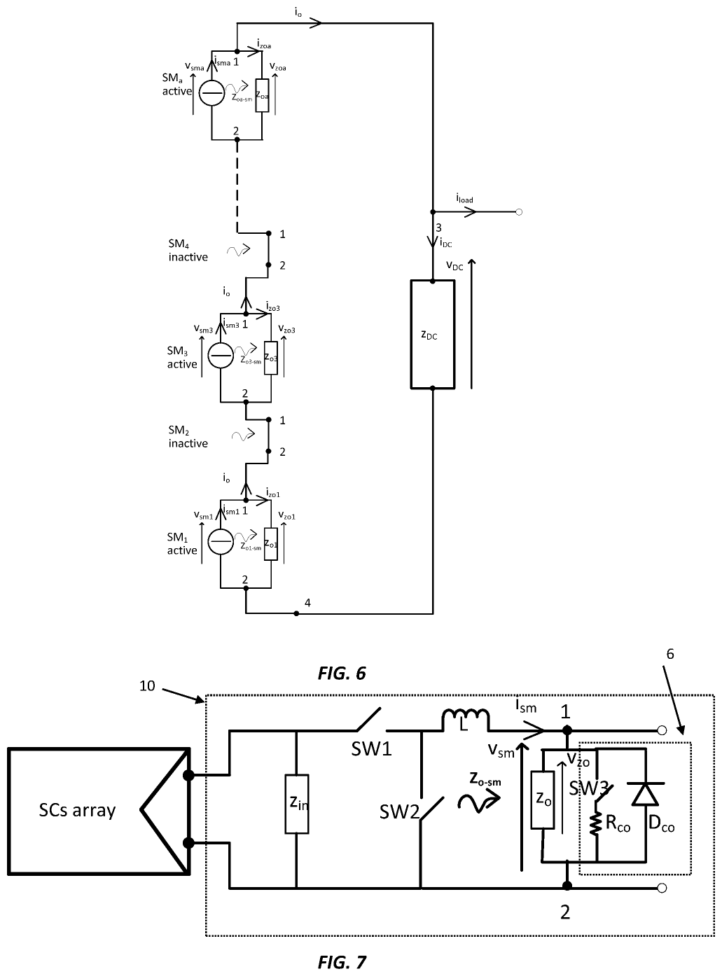

In order to consider the effect of a predetermined number of smart modules, it is possible to make reference to FIG. 6 where (iₛₘ≠0) a number a (a≤n) of modules is active. A module is defined active when at a given time its current ism results different from zero. In practice, a module may result to be active when its main switch (for example SW1 in FIG. 7) is closed for a predefined time within a working period. The remaining modules are deactivated (iₛₘ=0) and will be represented by their zₒⱼ. In this context a smart module is defined deactivated when its current iₛₘ results equal to zero. In practice, a module may result deactivated when its output voltage vₛₘ is discharged until zero (or its proximal value) or when the main switch (for example SW1 in FIG. 7) remains always open within a working period.

In this example, the conditioning circuit through its diode limits the output voltage of all deactivated smart modules to a value close to zero independently of the current crossing it. Then, ideally, such configuration is equivalent to a short circuit. The impedance zₒⱼ₋ₛₘ, seen from the smart module ‘j’, when the number of switched-on modules results to be ‘a’ is represented in the equation (16):

$${z}_{o j - s m} = {z}_{o j} \frac{1}{1 + a α} \qquad ( 16 )$$

With ‘a’≤n; wherein n is the number of smart modules composing a string.

Hereinafter the description of the behaviour of a module according to the invention is shown. FIG. 7 shows a circuit exemplifying a module according to the present invention in case the converter 10 associated thereto is an active converter of buck type, with conditioning circuit 6.

It is to be meant that the same behaviour could be obtained with other types of active converters, by modifying consequently the specific control modes, but maintaining operational the same base logic.

The conditioning circuit 6 contributes to perform four operating modes so as to make stable the operation of the smart module in the collective context:
to reduce the output voltage during a possible emergency state,
to limit the output voltage during the limited voltage operation state when the dynamics of the converter DC-DC is not sufficient to control the output voltage in the required periods of time,
to limit the output voltage close to zero when the smart module is inactive and in particular during the start-up period,
to bypass the smart module if the output impedance of the module zₒⱼ is excessive, for example upon the rupture of the output capacitor (zₒⱼ→∞).

In the example of FIG. 7, the conditioning circuit comprises:
a switch, SW3, connected in series to a resistance, R_{co}.
a diode, D_{co}, installed in parallel to the series SW3—R_{co}.

In a possible emergency state or operation state with limited voltage, the output voltage may be preferably reduced and/or limited by closing the switch SW3 for a predetermined required period of time.

The passive element (in this embodiment the diode), is useful to limit the output voltage of the smart module and to bypass the smart module when it is not active and/or when its zₒⱼ is excessive.

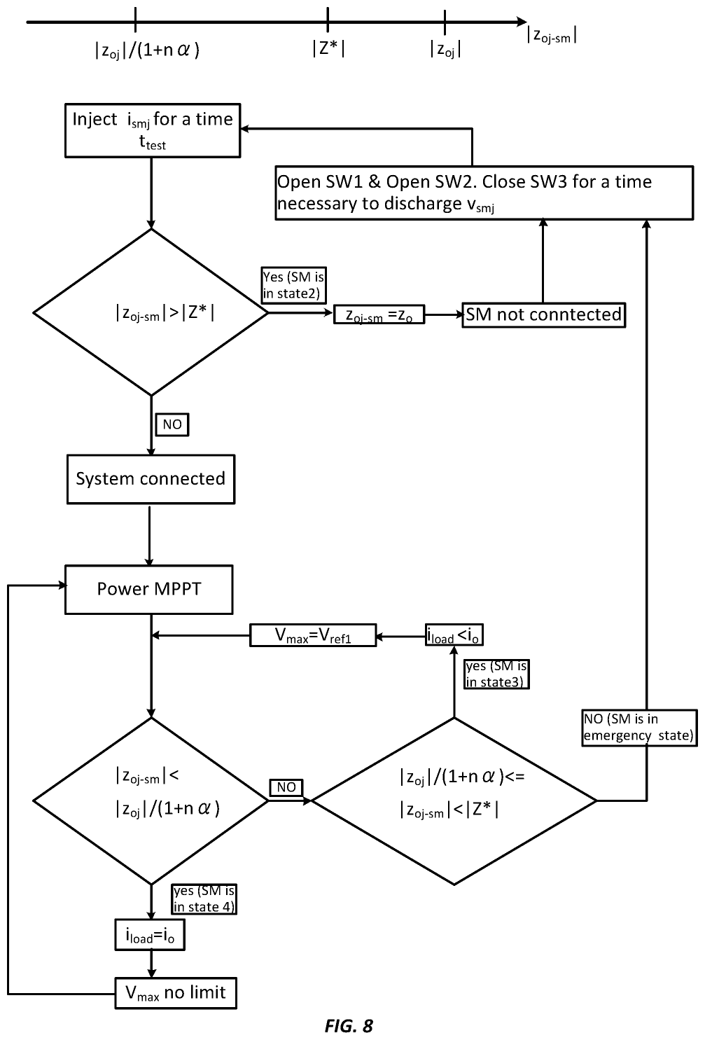

FIG. 8 shows a flow chart which reproduces the control logic implemented in the controller 4 of the converter 10 according to the invention.

In FIG. 8:
   |z| designates the impedance module;
   |Z*| is a threshold value comprised between |zⱼ|/(1+nα) and |zₒⱼ| to be determined during the planning phase;
tₜₑₛₜ is a time threshold to be determined during the planning phase;
Vₘₐₓ: is the maximum voltage measured at the output terminals of the converter (between the nodes 1 and 2);
V_{ref1}: is a reference voltage.

The flow chart of FIG. 8 represents the logic implemented by the controller of the converter according to the invention. According to such logic, the controller is configured to control the first and/or the second switching device (SW1, SW2, SW3) on the basis of the modulus of the output impedance value (zₒⱼ₋ₛₘ), so that:
a) when the modulus of the output impedance value (zₒⱼ₋ₛₘ) is lower than a first predetermined threshold value Z_{T1}, preferably equal to:

$${Z}_{T 1} = \vert {z}_{o j} \vert \frac{1}{1 + n α} ,$$

the controller commands the second switching device (SW3) to open, in such a way as to disable the conditioning circuit without limits on the output voltage;
b) when the modulus of the output impedance value (zₒⱼ₋ₛₘ) is greater than or equal to the first predetermined threshold value Z_{T1} and lower than a second predetermined threshold value Z_{T2} (|Z*| in FIG. 8), the controller 4 commands said first switching device (SW1, SW2) and said second switching device (SW3) in such a way as to maintain the output voltage (Vₘₐₓ) of the converter 10 at a value lower than or equal to a reference value (V_{ref1});
c) when the modulus of the output impedance value (zₒⱼ₋ₛₘ) is greater than or equal to said second predetermined threshold value Z_{T2}, the controller 4 commands the first switching device (SW1, SW2) to open and the second switching device (SW3) to close, in such a way as to bring the output voltage (Vₘₐₓ) of the converter to zero or to a value lower than said reference value (V_{ref1}) in a period of time lower than the period of time for reading (measuring and calculating) the output impedance value (zₒⱼ₋ₛₘ), and/or
d) consequently, when said modulus of the output impedance value (zₒⱼ₋ₛₘ) is greater than or equal to said second predetermined threshold value (Z_{T2}) and the output voltage (Vₘₐₓ) of the converter is equal to zero or lower than said reference value (V_{ref1}) the controller 4 commands said second switching device (SW3) to open and said first switching device (SW1, SW2) to close the main switch (SW1) and to open the switch (SW2), so as to inject current in the output capacitor in a lower period of time than the oscillation period of time of the circuit LC. During the capacitor charging, the controller 4 proceeds in measuring the output impedance modulus value (zₒⱼ₋ₛₘ). Then, depending upon the obtained output impedance modulus value, the smart module enters mode a) or b) or c).

In case the converter 10 is preferably equipped with a first switching device SW1, SW2, for example to implement MPPT functionality, according to the present invention the controller 4 may be configured to command even the first switching device, in the above-defined situations a), b), c) and d).

In particular, in the situation a), the controller 4, preferably, could even command the first switching device (SW1, SW2) based upon the MPPT algorithm without limits on the output voltage; in the situation b), the controller 4, preferably, could even command the first switching device (SW1, SW2) based upon the MPPT algorithm with limit on the output voltage whereas in the situations c) and d) the first switching device (SW1, SW2) could be commanded so as to disconnect electrically the converter from the photovoltaic module and, by closing the switching device SW3, to bring the output voltage under a certain threshold (or to zero), or, subsequently, so as to inject current in controlled way in the output capacity, with the purpose of continuing to monitor the output impedance modulus value with the help of the second switching device SW3.

The operation logic of the converter according to the invention is determined based upon the possible states in which the module can be found during its whole life: from the installation until the real electric production phase.

Then, the states associated to a general photovoltaic module under the various environmental and electric conditions and the behaviour of a module according to the invention for each state will be described hereinafter.

### State1

This state is not represented in the flow chart since the module results to be switched off. It represents the moments in which the module does not receive light, such as for example during transportation. Under these circumstances the self-feeding circuit of the module is not naturally available and the switches SW1 and SW2 are normally open. The switch of the conditioning circuit SW3 is open too.

### State 2

It represents a time range in which the module:
is receiving light
is not connected to the DC link (input of the converter DC/AC) through a string of modules. This may happen for example during the installation of the photovoltaic system.

In this phase the block for automatically supplying the module is available thanks to the power supply available from the module itself. Then, the controller 4 can start its automatic operation as described in the flow chart of FIG. 8. The module, through the operating functions of the controller 4, will be configured in order to be able to highlight its corresponding state through injection of a test current in the output stage for a predetermined period of time tₜₑₛₜ, lower than the oscillation time of the circuit al tempo LC composing the converter 10:
SW1=closed for a period of time equal to a fraction of tₜₑₛₜ.
SW2 open

The output voltage, vₛₘ, and the output current, iₛₘ, of the module will be measured during such test.

Consequently, the modulus of the output impedance, |zₒⱼ₋ₛₘ|, is calculated as:

$$\vert {z}_{oj - sm} \vert = \vert {v}_{s m} / {i}_{s m} \vert .$$

In this case, the obtained value of |zₒⱼ₋ₛₘ| corresponds to its output impedance |zₒⱼ|.

Consequently, at the end of the time range equal to tₜₑₛₜ, SW3 will be closed for a period of time corresponding to the time necessary to discharge the output capacitor of the module by bringing its output voltage vₛₘ back to zero.

While the module is self-powered, the test is repeated continuously until the module passes to state 3 or state 4.

### State 3

It represents a time range in which the module:
is receiving light
is connected to the DC link or the input capacitor of the DC/AC inverter stage.
the output inverter is not yet connected to the network or the network is not available.

The block for automatically supplying the module is available due the power supply coming from the module itself.

The controller starts its automatic operation through the proposed flow chart of FIG. 8.

The test step is performed as the flow chart of FIG. 8. The module of the impedance zₒⱼ₋ₛₘ results to be <<|zₒ| and in particular equal to |zₒ|/(1+na) where a represents the number of active smart modules.

Consequently, the controller will activate the control with limited output voltage at the value close to V_{ref1} equal to 1500/n. The output current, iₒ, will be close to zero and consequently the controller will command SW1 and SW2 in voltage control mode and in case the conditioning circuit could intervene occasionally through SW3 to allow the current to circulate between the node 1 and the node 2 (FIG. 7). In this operation mode the controller preferably can activate the MPPT algorithm by considering that the switches SW1, SW2 and SW3 are commanded by giving priority to the limitation of the output voltage to Vref1.

For example, if the number of modules connected in series is n=90, the duty cycle will be controlled so as to keep the output voltage at the reference value vref1 equal to 1500/90˜16 V.

### State 4

It represents a time range in which the module:
is receiving light
is connected to the input capacitor of the inverter.
the inverter output is connected to the network
the network is available.

The block for automatically supplying the module is available due to the power supply coming from the module.

At the beginning of this time range, the last calculated output impedance |Zo-sm| results to be equal to |zₒⱼ|/(1+nα).

During this time range, the network is available and starts to absorb the load. The new calculated output impedance value of the modulus results to be very small and much smaller than |zₒⱼ|/(1+nα). Consequently, the output voltage of the module will be no more controlled during the normal operation.

The removal of the output voltage limitation allows the smart PV module to operate freely, preferably according to the MPPT algorithm, by supporting a wide mismatching range between smart PV modules belonging to the same string.

The duty cycle can be modified only after the controller's consensus depending upon the value of |zₒⱼ₋ₛₘ| and preferably it is modified at a defined frequency in the MPPT algorithm.

The second controllable switching device SW3, included in the conditioning circuit 6, will be open since no emergency action is required.

Preferably, the inverter is configured so as to keep, in this situation, the DC link, or its input voltage, at a voltage close to the operating one (near the limit imposed by standards) through a ‘current loop’ control.

### State 5

It represents a time range corresponding to a failure condition.

Before being in the state 5 the smart PV module could be found in state 3 or state 4.

The last calculated value of |zₒⱼ₋ₛₘ| before being in State 5 is s |zₒⱼ|/(1+nα).

The new calculated value of |zₒⱼ₋ₛₘ| will be >|Zₒ|/(1+nα) (exactly equal to |zₒⱼ|).

The module will enter an emergency area and the controller 4 will act as follow:
opening SW1 and closing SW2 of said first controllable switching device,
closing said second controllable switching device SW3 for the period of time necessary to discharge the output voltage,
restarting iteratively with the test cycle.

Said system allows the inverter operation with a very small operating range of the input voltage than the typical working range 400-1200V. For example, for a constant operating voltage close to 1450V, it is possible to consider a minimum switching-on voltage of 1300V so as to increase the system efficiency under all radiation and temperature conditions.

The operation with highest voltage close to the maximum voltage referred in the standards of the field involves a significant increase in performance.

Moreover, the autonomy of the photovoltaic modules involves a simplification both in the input circuits and in the inverter control system.

During the operation in State 4, by using an inverter useful to keep constant the voltage V_{DC}, the apparent capacity of the DC link results to be infinite; consequently, z_{DC} tends to zero as well as the impedance value zₒⱼ₋ₛₘ tends to zero (equation 14). Under these conditions, it will be possible to recognize the state 4 even thanks to the impedance phase zₒⱼ₋ₛₘ which has no more a wholly capacitive behaviour.

In other words, it is possible to implement the operation of the active electronic converter 10 for example in the State 4 not necessarily by monitoring the absolute value of the impedance but by analysing the phase thereof.

Such process can even be implemented for example through the same circuit configured to allow to detect a variation in the impedance phase zₒⱼ₋ₛₘ upon varying the possible use states.

### Additional Embodiments

According to an additional embodiment, one provides to measure (directly or indirectly) or to calculate the phase value of the output impedance, θ_{zoj-sm}, of the smart module with the purpose of trying to identify the operation state of the module.

Considering the smart module not yet connected to the DC-link, it is possible to obtain the impedance value, zₒⱼ₋ₛₘ, as it was calculated through the equation (8), that is:

$${z}_{o j - s m} = \frac{{v}_{s m}}{{i}_{s m}} = {z}_{o} ;$$

Consequently, the phase of the output impedance θzₒⱼ₋ₛₘ results to be of capacitive type close to −90°.

When the DC-link is inserted in the circuit one can refer to the equation (15) which is shown hereinafter

$${z}_{o j - s m} = {z}_{o j} \frac{1}{1 + n α}$$

Again, the phase of the output impedance θzₒⱼ₋ₛₘ results to be of capacitive type close to −90°.

Then, by using the phase it is difficult to distinguish between the not yet connected device rather than connected to the DC-link through closing the string of the smart module on the DC link in absence of load.

When a load is inserted, represented by R, in parallel to the DC-link, the impedance of the DC-link becomes the following:

$${z}_{D C} = R \frac{{z}_{o j}}{{z}_{o j} + α R} \qquad ( 17 )$$

By inserting the result of the equation (17) in the equation (15) an approximation of the effect is obtained having the load on the apparent output impedance of the single converter of the smart module:

$${z}_{o j - s m} = R \frac{1}{s C R + n ( 1 + α R )} \qquad ( 18 )$$

It is possible to observe that for the typical capacity value of the output capacitor of about few μF and for resistance value R greater than 0 and lower than or equal to 100Ω covering a wide window for the load current, as far as the reading of the output impedance of the single converter is concerned it is possible to approximate the phase of the output impedance θzₒⱼ₋ₛₘ of resistive type to a value close to 0°.

In this way, it is then possible to distinguish, by using the phase of the output impedance, if the smart module is connected to a load.

In conclusion, by introducing a reference phase value, θ_{rif.}, preferably higher than or equal to −90° and lower than 0°, it will be possible to discriminate between the situation a) and the situations b), c) and d) described previously.

The measurement of the output impedance phase is particularly cost-effective since it is an integrating portion of the measurement of the output impedance itself and the phase verification can be used together with the impedance one, this resulting in a greater robustness of the decisional phase, this with particular relevance in the emergency identification phase wherein each additional element in the condition estimation helps removing uncertainty and then making the decisional criteria more stringent and possibly quicker and with a lower decisional failure incidence.

Alternatively, according to a possible embodiment, the phase measurement can replace the impedance ones.

The present invention has been so far described with reference to its preferred embodiments. It is to be meant that each one of the technical solutions implemented in the preferred embodiments, herein described by way of example, can advantageously be combined, differently from what described, with the other ones, to create additional embodiments, belonging to the same inventive core and however all within the protective scope of the here below reported claims.

1. An active electronic converter for one or more photovoltaic modules, comprising:
a first controllable switching device (SW1, SW2),
a conditioning circuit connected in parallel to the output of the converter and comprising a second controllable switching device (SW3) arranged to form a shunt circuit;
means for measuring an output impedance value (zₒⱼ₋ₛₘ) of the converter;
a controller configured to control said first and second switching devices (SW1, SW2, SW3) on the basis of the modulus of said output impedance value (zₒⱼ₋ₛₘ), wherein:
a) when said modulus of the output impedance value (zₒⱼ₋ₛₘ) is lower than a first predetermined threshold value (Z_{T1}) the controller commands said second switching device (SW3) to open, to disable the conditioning circuit without limits on the output voltage;
b) when said modulus of the output impedance value (zₒⱼ₋ₛₘ) is greater than or equal to said first predetermined threshold value (Z_{T1}) and lower than a second predetermined threshold value (Z_{T2}), the controller commands said first switching device (SW1, SW2) and said second switching device (SW3) to maintain the output voltage (Vₘₐₓ) of the converter at a value lower than or equal to a reference value (V_{ref1});
c) when said modulus of the output impedance value (zₒⱼ₋ₛₘ) is greater than or equal to said second predetermined threshold value (Z_{T2}), the controller commands said first switching device (SW1, SW2) to open and said second switching device (SW3) to close, to bring the output voltage (Vₘₐₓ) of the converter to zero or to a value lower than said reference value (V_{ref1}); and
d) when said modulus of the output impedance value (zₒⱼ₋ₛₘ) is greater than or equal to said second predetermined threshold value (Z_{T2}) and the output voltage (Vₘₐₓ) of the converter is equal to zero or lower than said reference value (V_{ref1}) the controller commands said second switching device (SW3) to open and said first switching device (SW1, SW2) to close the main switch (SW1) and to open the switch (SW2), to inject current in the output capacitor.

2. The active electronic converter according to claim 1, wherein said controller is configured to control, in a), said first switching device (SW1, SW2) on the basis of an MPPT algorithm without limits on the output voltage.

3. The active electronic converter according to claim 1, wherein said first threshold value (Z_{T1}) is equal to
$${Z}_{T 1} = \vert {z}_{o j} \vert \frac{1}{1 + n α}$$
wherein: zₒⱼ is the physical output impedance of the active electronic converter, n is the number of modules to be connected in series to form a string, a is the ratio between zₒⱼ and z_{dc} wherein z_{dc} is the DC link input impedance.

4. The active electronic converter according to claim 1, wherein said second threshold value (Z_{T2}) is between |zₒⱼ|/(1+nα) and |zₒⱼ|.

5. The active electronic converter according to claim 1, wherein said conditioning circuit comprises:
an active switching element (SW3), adapted to form a local shunt circuit; and
a passive element, apt to limit the negative voltage at the output of the converter, placed in parallel to said active switching element (SW3).

6. The active electronic converter according to claim 5, wherein said active switching element (SW3) is a transistor connected in series to a resistor, and said passive element is a diode.

7. The active electronic converter according to claim 1, further comprising means for measuring a phase (θ_{zoj-sm}) of the output impedance (zₒⱼ₋ₛₘ) of the converter, wherein said controller is configured to control said first and second switching devices (SW1, SW2, SW3) on the basis of the modulus of said output impedance value (zₒⱼ₋ₛₘ) and said phase value (θ_{zoj-sm}), wherein:
e) when said modulus of the output impedance value (zₒⱼ₋ₛₘ) is lower than a first predetermined threshold value (Z_{T1}) and said phase value (θ_{zoj-sm}) is higher than a reference phase value (θ_{rif}), the controller commands said second switching device (SW3) to open, to disable the conditioning circuit without limits on the output voltage;
f) when said modulus of the output impedance value (zₒⱼ₋ₛₘ) is greater than or equal to said first predetermined threshold value (Z_{T1}) and lower than a second predetermined threshold value (Z_{T2}) and said phase value (θ_{zoj-sm}) is lower than or equal to a reference phase value (θ_{rif}), the controller commands said first switching device (SW1, SW2) and said second switching device (SW3) to maintain the output voltage (Vₘₐₓ) of the converter at a value lower than or equal to a reference value (V_{ref1});
g) when said modulus of the output impedance value (zₒⱼ₋ₛₘ) is greater than or equal to said second predetermined threshold value (Z_{T2}) and said phase value (θ_{zoj-sm}) is lower than or equal to a reference phase value (θ_{rif}), the controller commands said first switching device (SW1, SW2) to open and said second switching device (SW3) to close, to bring the output voltage (Vₘₐₓ) of the converter to zero or to a lower value than said reference value (V_{ref1}); and
h) when said modulus of the output impedance value (zₒⱼ₋ₛₘ) is greater than or equal to said second predetermined threshold value (Z_{T2}) and the output voltage (Vₘₐₓ) of the converter is equal to zero or lower than said reference value (V_{ref1}) and said phase value (θ_{zoj-sm}) is lower than or equal to a reference phase value (θ_{rif}), the controller commands said second switching device (SW3) to open and said first switching device (SW1, SW2) to close the main switch (SW1) and to open the switch (SW2), to inject current in the output capacitor.

8. An active electronic converter for one or more photovoltaic modules, comprising:
a first controllable switching device (SW1, SW2),
a conditioning circuit connected in parallel to the output of the converter (10) and comprising a second controllable switching device (SW3) arranged to form a shunt circuit;
means (3) for measuring a phase value (θ_{zoj-sm}) of the output impedance (zₒⱼ₋ₛₘ) of the converter;
a controller configured to control said first and second switching devices (SW1, SW2, SW3) based upon said phase value (θ_{zoj-sm}), so that:
i) when said phase value (θ_{zoj-sm}) is higher than a reference phase value (θ_{rif}) the controller commands said second switching device (SW3) to open, as to disable the conditioning circuit without limits on the output voltage; and
j) when said phase value (θ_{zoj-sm}) is lower than or equal to a reference phase value (θ_{rif}) the controller commands said first switching device (SW1, SW2) and said second switching device (SW3) to maintain the output voltage (Vₘₐₓ) of the converter at a value lower than or equal to a reference value (V_{ref1}).

9. The active electronic converter according to claim 7, wherein said reference phase value (θ_{rif}) is greater than or equal to −90° and lower than 0°.

10. A photovoltaic module comprising a converter according to claim 1.

11. A photovoltaic string comprising a plurality of photovoltaic modules according to claim 10 connected in series.

12. A method for controlling an active electronic converter for one or more photovoltaic modules, the converter comprising a first controllable switching device (SW1, SW2), a conditioning circuit connected in parallel to the output of the converter and comprising a second controllable switching device (SW3) arranged to form a shunt circuit, the method comprising:
k) measuring an output impedance value (zₒⱼ₋ₛₘ) of said converter;
l) controlling said first and second switching device (SW1, SW2, SW3) on the basis of the modulus of said output impedance value (zₒⱼ₋ₛₘ), wherein:
a) when said modulus of the output impedance value (zₒⱼ₋ₛₘ) is lower than a first predetermined threshold value (Z_{T1}) said second switching device (SW3) is controlled to open to disable the conditioning circuit without limits on the output voltage;
b) when said modulus of the output impedance value (zₒⱼ₋ₛₘ) is greater than or equal to said first predetermined threshold value (Z_{T1}) and lower than a second predetermined threshold value (Z_{T2}), said first switching device (SW1, SW2) and said second switching device (SW3) are controlled to maintain the output voltage (Vₘₐₓ) of the converter at a value lower than or equal to a reference value (V_{ref1});
c) when said modulus of the output impedance value (zₒⱼ₋ₛₘ) is greater than or equal to said second predetermined threshold value (Z_{T2}), said first switching device (SW1, SW2) is controlled to open and said second switching device (SW3) is controlled to close to bring the output voltage (Vₘₐₓ) of the converter to zero or to a value lower than said reference value (V_{ref1}); and
d) when said modulus of the output impedance value (zₒⱼ₋ₛₘ) is greater than or equal to said second predetermined threshold value (Z_{T2}) and the output voltage (Vₘₐₓ) of the converter is equal to zero or lower than said reference value (V_{ref1}) the controller commands said second switching device (SW3) to open and said first switching device (SW1, SW2) to close the main switch (SW1) and to open the switch (SW2), to inject current in the output capacitor.

13. The control method according to claim 12, wherein in states a) and b), said first switching device (SW1, SW2) is controlled on the basis of an MPPT algorithm.

14. The control method according to claim 12, wherein said first threshold value (Z_{T1}) is equal to
$${Z}_{T 1} = \vert {z}_{o j} \vert \frac{1}{1 + n α}$$
wherein: zₒⱼ is the physical output impedance of the active electronic circuit, n is the number of modules to be connected in series to form a string, a is the ratio between zₒⱼ and z_{dc} wherein z_{dc} is the DC link input impedance.

15. The control method according to claim 12, wherein said second threshold value (Z_{T2}) is between |zₒⱼ|/(1+nα) and |zₒⱼ|.

16. The method according to claim 12, wherein before activating said phase a) or after having activated said phase c) one proceeds with injecting by means of said first switching device (SW1, SW2) a predetermined test current in said active electronic converter to measure a corresponding output impedance value (zₒⱼ₋ₛₘ).

17. The method according to claim 12, further comprising a step of measuring a phase value (θ_{zoj-sm}) of the output impedance (zₒⱼ₋ₛₘ) of said converter, wherein step of controlling said first and second switching device (SW1, SW2, SW3) is performed on the basis of the modulus of said output impedance value (zₒⱼ₋ₛₘ), wherein:
e) when said modulus of the output impedance value (zₒⱼ₋ₛₘ) is lower than a first predetermined threshold value (Z_{T1}) and said phase value (θ_{zoj-sm}) is higher than a reference phase value (θ_{rif}), the controller commands said second switching device (SW3) to open, to disable the conditioning circuit without limits on the output voltage;
f) when said modulus of the output impedance value (zₒⱼ₋ₛₘ) is greater than or equal to said first predetermined threshold value (Z_{T1}) and lower than a second predetermined threshold value (Z_{T2}) and said phase value (θ_{zoj-sm}) is lower than or equal to a reference phase value (θ_{rif}), the controller commands said first switching device (SW1, SW2) and said second switching device (SW3) to maintain the output voltage (Vₘₐₓ) of the converter at a value lower than or equal to a reference value (V_{ref1});
g) when said modulus of the output impedance value (zₒⱼ₋ₛₘ) is greater than or equal to said second predetermined threshold value (Z_{T2}) and said phase value (θ_{zoj-sm}) is lower than or equal to a reference phase value (θ_{rif}), the controller commands said first switching device (SW1, SW2) to open and said second switching device (SW3) to close, to bring the output voltage (Vₘₐₓ) of the converter to zero or to a value lower than said reference value (V_{ref1}); and
h) when said modulus of the output impedance value (zₒⱼ₋ₛₘ) is greater than or equal to said second predetermined threshold value (Z_{T2}) and the output voltage (Vₘₐₓ) of the converter is equal to zero or lower than said reference value (V_{ref1}) and said phase value (θ_{zoj-sm}) is lower than or equal to a reference phase value (θ_{rif}), the controller commands said second switching device (SW3) to open and said first switching device (SW1, SW2) to close the main switch (SW1) and to open the switch (SW2), to inject current in the output capacitor.

18. A method for controlling an active electronic converter for one or more photovoltaic modules, the converter comprising a first controllable switching device (SW1, SW2), a conditioning circuit connected in parallel to the output of the converter and comprising a second controllable switching device (SW3) arranged to form a shunt circuit, the method comprising the following steps:
measuring a phase value (θ_{zoj-sm}) of the output impedance (zₒⱼ₋ₛₘ) of said converter;
controlling said first and second switching device (SW1, SW2, SW3) based upon said phase value (θ_{zoj-sm}), wherein:
i) when said phase value (θ_{zoj-sm}) is higher than a reference phase value (θ_{rif}) the controller commands said second switching device (SW3) to open, to disable the conditioning circuit without limits on the output voltage; and
j) when said phase value (θ_{zoj-sm}) is lower than or equal to a reference phase value (θ_{rif}) the controller commands said first switching device (SW1, SW2) and said second switching device (SW3) to maintain the output voltage (Vₘₐₓ) of the converter at a value lower than or equal to a reference value (V_{ref1}).

19. The method according to claim 17, wherein said reference phase value (θ_{rif}) is greater than or equal to −90° and lower than 0°.
